(19) United States
(12) Patent Application Publication
(10) Pub. No.: US 2019/0335391 A1
(43) Pub. Date: Oct. 31, 2019

(54) DEVICE AND METHOD FOR SELECTING CORE NETWORK IN WIRELESS COMMUNICATION SYSTEM

(71) Applicant: Samsung Electronics Co., Ltd, Suwon-si (KR)

(72) Inventors: Sangwook KWON, Suwon-si (KR); Joohyung LEE, Gwacheon-si (KR); Beomsik BAE, Suwon-si (KR); Jungsoo JUNG, Seongnam-si (KR); Sangjun MOON, Seoul (KR)

(21) Appl. No.: 16/347,556

(22) PCT Filed: Nov. 1, 2017
(86) PCT No.: PCT/KR2017/012251

§ 371 Date: May 3, 2019

(30) Foreign Application Priority Data
Nov. 4, 2016 (KR) 10-2016-0146350

(51) Int. Cl. H04W 48/18; H04W 76/11; H04W 76/27; H04L 29/06

(52) U.S. Cl. CPC H04W 48/18; H04W 76/11; H04W 84/042; H04L 69/22; H04W 76/27

(57) ABSTRACT

The present disclosure relates to a 5th generation (5G) or pre-5G communication system for supporting a higher data transmission rate beyond a 4th generation (4G) communication system such as long term evolution (LTE). The present disclosure is for selecting a core network for a terminal in a wireless communication system, wherein an operation method of the terminal comprises the steps of: creating a message including information used for selecting a core network; and transmitting the message to a base station. Here, the information includes a value corresponding to a core network among mutually different core networks with which a connection may be made at the base station.

### CROSS-REFERENCE TO RELATED APPLICATIONS

This application is a 371 of International Application No. PCT/KR2017/012251 filed on Nov. 1, 2017, which claims priority to Korean Patent Application No. 10-2016-0146350 filed on Nov. 4, 2016, the disclosures of which are herein incorporated by reference in their entirety.

### BACKGROUND

### 1. Field

The disclosure generally relates to a wireless communication system, and more particularly, relates to an apparatus and a method for selecting a core network in the wireless communication system.

### 2. Description of Related Art

### Background Art

To meet the demand for wireless data traffic having increased since deployment of 4^{th} generation (4G) communication systems, efforts have been made to develop an improved 5^{th} generation (5G) or pre-5G communication system. Therefore, the 5G or pre-5G communication system is also called a ‘Beyond 4G Network’ or a ‘Post Long Term Evolution (LTE) System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

In the 5G system, Hybrid frequency shift keying (FSK) and quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

In addition, as the 5G system is introduced, an environment where the 4G system and the 5G system coexist may be considered. In this case, different core networks may coexist.

### SUMMARY

Based on the discussions described above, the disclosure provides an apparatus and a method for selecting a core network in a wireless communication system.

In addition, the disclosure provides an apparatus and a method for selecting a core network according to type of a terminal in a wireless communication system.

In addition, the disclosure provides an apparatus and a method for notifying a type of a terminal through a message signaled between the terminal and a base station in a wireless communication system.

In addition, the disclosure provides an apparatus and a method for notifying a type of a terminal through a message of a radio link control (RRC) layer in a wireless communication system.

In addition, the disclosure provides an apparatus and a method for identifying a type of a terminal based on network identification information in a wireless communication system.

In addition, the disclosure provides an apparatus and a method for determining whether a base station supports accesses to a plurality of core networks in a wireless communication system.

According to various embodiments of the disclosure, a method for operating a terminal in a wireless communication system includes generating a message including information that is used to select a core network, and transmitting the message to a base station. Herein, the information includes a value corresponding to one of different core networks connectable by the base station.

According to various embodiments of the disclosure, a method for operating a base station in a wireless communication system includes receiving from a terminal a message that includes information used to select a core network, and transmitting a message for attaching to a core network for the terminal determined based on the information. Herein, the information includes a value corresponding to one of different core networks connectable by the base station.

According to various embodiments of the disclosure, a method for operating a device included in a core network in a wireless communication system includes receiving a message that requests an attach of a terminal, and controlling to forward the message to a different core network if the message is a message processible in the different network from a core network of the apparatus.

According to various embodiments of the disclosure, an apparatus for a terminal in a wireless communication system includes a controller configured to generate a message including information that is used to select a core network, and a transmitter configured to transmit the message to a base station. Herein, the information includes a value corresponding to one of different core networks connectable by the base station.

According to various embodiments of the disclosure, an apparatus for a base station in a wireless communication system includes a wireless communication unit configured to receive from a terminal a message that includes information used to select a core network, and a backhaul communication unit configured to transmit a message for attaching to a core network for the terminal determined based on the information. Herein, the information includes a value corresponding to one of different core networks connectable by the base station.

According to various embodiments of the disclosure, a apparatus in a core network in a wireless communication system includes a communication unit configured to receive a message that requests an attach of a terminal, and a controller configured to control to forward the message to a different core network if the message is a message processible in the different network from a core network of the apparatus.

An apparatus and a method according to various embodiments of the disclosure may enable a terminal to access a suitable communication system in an environment where a plurality of core networks coexists, by forwarding a message of an upper layer to an appropriate core network for the terminal in a core network, or by transmitting a message of an upper layer to an appropriate core network for the terminal in a wireless access network. Further, various embodiments may minimize changes of the existing system, and provide the aforementioned effect.

Effects obtainable from the disclosure are not limited to the above mentioned effects, and other effects which are not mentioned may be clearly understood by those skilled in the art of the present invention through the following descriptions.

### BRIEF DESCRIPTION OF THE DRAWINGS

FIG. 1 illustrates a wireless communication system according to various embodiments of the disclosure.

FIG. 2 illustrates a configuration of a base station in a wireless communication system according to various embodiments of the disclosure.

FIG. 3 illustrates a configuration of a terminal in a wireless communication system according to various embodiments of the disclosure.

FIG. 4 illustrates a configuration of a communication unit in a wireless communication system according to various embodiments of the disclosure.

FIG. 5 illustrates a configuration of an upper node in a wireless communication system according to various embodiments of the disclosure.

FIG. 6 illustrates an operating method of a core network device in a wireless communication system according to various embodiments of the disclosure.

FIG. 7A illustrates a procedure for re-routing a message from a second core network to a first core network in a wireless communication system according to various embodiments of the disclosure.

FIG. 7B illustrates a detailed procedure for re-routing the message from the second core network to the first core network in the wireless communication system according to various embodiments of the disclosure.

FIG. 8A illustrates a procedure for re-routing a message from a first core network to a second core network in a wireless communication system according to various embodiments of the disclosure.

FIG. 8B illustrates a detailed procedure for re-routing the message from the first core network to the second core network in the wireless communication system according to various embodiments of the disclosure.

FIG. 9 illustrates an operating method of a terminal in a wireless communication system according to various embodiments of the disclosure.

FIG. 10 illustrates an operating method of a base station in a wireless communication system according to various embodiments of the disclosure.

FIG. 11A illustrates a procedure for providing information relating to core network selection using a message for a connection request in a wireless communication system according to various embodiments of the disclosure.

FIG. 11B illustrates another procedure for providing information relating to the core network selection using the message for the connection request in the wireless communication system according to various embodiments of the disclosure.

FIG. 12 illustrates a procedure for providing information relating to core network selection using a message for connection confirmation in a wireless communication system according to various embodiments of the disclosure.

FIG. 13 illustrates another procedure for providing information relating to core network selection using a message for connection confirmation in a wireless communication system according to various embodiments of the disclosure.

FIG. 14 illustrates a procedure for providing information relating to core network selection using identification information for an operator in a wireless communication system according to various embodiments of the disclosure.

FIG. 15 illustrates another operating method of a terminal in a wireless communication system according to various embodiments of the disclosure.

FIG. 16 illustrates a procedure for initiating a procedure which provides information relating to core network selection using operator identification information in a wireless communication system according to various embodiments of the disclosure.

### DETAILED DESCRIPTION

The terms used in the disclosure are only used to describe specific embodiments, and are not intended to limit other embodiments. Singular expressions may include plural expressions as well unless the context clearly indicates otherwise. All terms used herein, including technical and scientific terms, may have the same meaning as those commonly understood by a person skilled in the art to which the disclosure pertains. Terms such as those defined in a generally used dictionary among the terms used in the disclosure may be interpreted to have the meanings equal or similar to the contextual meanings in the relevant field of art, and are not to be interpreted to have ideal or excessively formal meanings unless clearly defined in the disclosure. In some cases, even a term defined in the disclosure should not be interpreted to exclude embodiments of the disclosure.

In various embodiments of the disclosure to be described below, a hardware approach will be described as an example. However, since the various embodiments of the disclosure include a technology using both hardware and software, the various embodiments of the disclosure do not exclude a software-based approach.

Hereafter, the disclosure relates to an apparatus and a method for providing selecting a core network in a wireless communication system. More specifically, the disclosure describes a technique for determining the core network according to a type of a terminal in the wireless communication system.

Terms indicating signals, terms indicating channels, terms indicating control information, terms indicating protocol layers, terms indicating network entities, and terms indicating components of an apparatus, which are used in the following descriptions, are for the sake of explanations. Accordingly, the disclosure is not limited to the terms to be described, and may use other terms having technically identical meaning.

In addition, the disclosure describes various embodiments using terms used in some communication standards (e.g., Long Term Evolution (LTE) system and LTE-advanced (LTE-A)), which is merely an example for explanations. Various embodiments of the disclosure may be easily modified and applied in other communication systems.

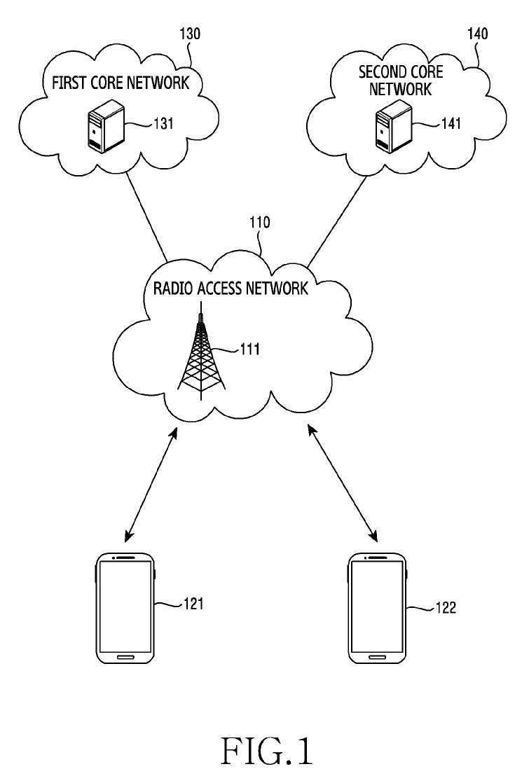

FIG. 1 illustrates a wireless communication system according to various embodiments of the disclosure. FIG. 1 illustrates a base station 111, a terminal 121, a terminal 122, an upper node 131, and an upper node 141, as nodes which use a radio channel in the wireless communication system. While FIG. 1 depicts the single base station, two upper nodes, and two terminals, the same or similar other entities may be further included.

A radio access network 110 is an infrastructure for providing radio access to the terminal 121 and the terminal 122. The radio access network 110 includes the base station 111. The base station 111 has coverage defined as a geographical area, based on a signal transmission distance. The base station 111 supports an interface capable of accessing two or more different core networks (e.g., the first core network 130, the second core network 140). The radio access network 110 may be referred to as a universal terrestrial radio access network (UTRAN), an evolved UTRAN (EUTRAN), an evolved EUTRAN (E-EUTRAN), or other term having a technically equivalent meaning. In addition, the base station 111 may be referred to as, besides the base station, an access point (AP), an eNodeB (eNB), a 5th generation node (5G node), a wireless point, a transmission/reception point (TRP), or other term having a technically equivalent meaning.

The terminal 121 and the terminal 122 each are a device used by a user, and perform communication with the base station 111 over a radio channel. In some cases, at least one of the terminal 121 and the terminal 122 may be operated without user's involvement. For example, at least one of the terminal 121 and the terminal 122 is a device for performing machine type communication (MTC), and may not be carried by the user. At this time, the terminal 121 has a property which may be serviced by the first core network 130. The terminal 122 has a property which may be serviced by the second core network 140. The terminal 121 and the terminal 122 each may be referred to as, besides the terminal, a user equipment (UE), a mobile station, a subscriber station, a remote terminal, a wireless terminal, or a user device, or other term having a technically equivalent meaning.

The first core network 130 is an infrastructure for supporting a user plane and a control plane of a first system (e.g., a 4G system). To this end, the first core network 130 includes at least one network entity including an upper node 131. For example, the at least one network entity may include at least one of a mobility management entity (MME), a serving gateway (S-GW), a packet data network gateway (P-GW), and a home subscriber server (HSS). The first core network 130 may be referred to as an evolved packet core (EPC), a 4G core, an LTE-core, or other terms having the equivalent technical meaning.

The second core network 140 is an infrastructure for supporting a user plane and a control plane of a second system (e.g., a 5G system). Herein, the second system is a different system from the first system corresponding to the first core network 130, and, for example, may be an improved system of the first system. In this case, the second core network 140 may have a differentiated functionality or structure from the first core network 130. For example, the second core network 140 may be designed in a structure to support virtualization technology which implements functions of network dedicated equipment belonging to hardware in the first core network 130 based on software, and to operate those functions in a general-purpose server. In addition, the second core network 140 may be dynamically operated to meet requirements of improved services such as Internet of things (IoT), high-quality streaming, low-delay service through the virtualization based structure. Specifically, the second core network 140 may support network slice and virtualization, quality of service (QoS) control per flow, and separation of the user plane and the control plane, separation of session management and mobility management, and new authentication technologies. For doing so, the second core network 140 includes at least one network entity including an upper node 141. For example, the at least one network entity may include at least one of a GW, a user plane core device, a control plane core device, and a general-purpose device for adaptively or selectively performing various functions. The first core network 130 may be referred to as a 5G core, a new radio (NR) core (NRC), a next generation (NG) core (NGC), or other terms having technically equivalent meanings.

According to an embodiment, the base station 111 and the terminal 122 may transmit and receive radio signals in a millimeter wave (mmWave) band (e.g., 28 GHz, 30 GHz, 38 GHz, 60 GHz). In so doing, to improve channel gain, the base station 111, the terminal 121, and the terminal 122 may conduct beamforming. Herein, beamforming includes transmit beamforming and receive beamforming. That is, the base station 111 and the terminal 122 may apply directivity to a transmit signal or a receive signal. For doing so, the base station 111 and the terminals 121 and 122 may select at least one serving beam through a beam search procedure. According to another embodiment, the base station 111 may not support the beamforming.

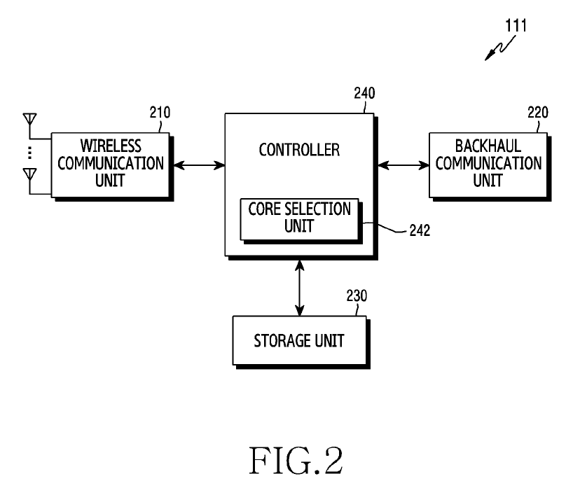

FIG. 2 illustrates a configuration of a base station in a wireless communication system according to various embodiments of the disclosure. The configuration of FIG. 2 may be understood as a configuration of the base station 111. A term such as ‘portion’ or ‘˜ er’ indicates a unit for processing at least one function or operation, and may be implemented using hardware, software, or a combination of hardware and software.

Referring to FIG. 2, the base station 111 includes a wireless communication unit 210, a backhaul communication unit 220, a storage unit 230, and a controller 240.

The wireless communication unit 210 may perform functions for transmitting and receiving signals over a radio channel. For example, the wireless communication unit 210 performs a conversion function between a baseband signal and a bit string according to a physical layer standard of a system. For example, in data transmission, the wireless communication unit 210 generates complex symbols by encoding and modulating a transmit bit string. Also, in data reception, the wireless communication unit 210 restores a receive bit string by demodulating and decoding a baseband signal. Also, the wireless communication unit 210 up-converts the baseband signal to a radio frequency (RF) band signal, transmits it via an antenna, and down-converts an RF band signal received via an antenna to a baseband signal.

For doing so, the wireless communication unit 210 may include a transmit filter, a receive filter, an amplifier, a mixer, an oscillator, a digital to analog convertor (DAC), an analog to digital convertor (ADC), and so on. In addition, the wireless communication unit 210 may include a plurality of transmit and receive paths. Further, the wireless communication unit 210 may include at least one antenna array including a plurality of antenna elements. In terms of the hardware, the wireless communication unit 210 may include a digital unit and an analog unit, and the analog unit may include a plurality of sub-units according to an operating power and an operating frequency.

The wireless communication unit 210 transmits and receives the signals as stated above. Hence, the wireless communication unit 210 may be referred to as a transmitter, a receiver, or a transceiver. Also, in the following, the transmission and the reception over the radio channel is used as the meaning which embraces the above-stated processing of the wireless communication unit 210.

The backhaul communication unit 220 provides an interface for communicating with other nodes (e.g., the upper node 131, the upper node 141) in the network. That is, the backhaul communication unit 220 converts a bit sting transmitted from the base station to another node, for example, to another access node, another base station, an upper node, or a core network, to a physical signal, and converts a physical signal received from the other node to a bit string. According to various embodiments, the backhaul communication unit 220 provides functions for connecting core networks of different systems. For doing so, the backhaul communication unit 220 may include two communication modules which are physically separated, or an integrated communication module which supports a plurality of core networks.

The storage unit 230 stores a basic program for operating the base station 111, an application program, and data such as setting information. The storage unit 230 may include a volatile memory, a non-volatile memory, or a combination of a volatile memory and a non-volatile memory. The storage unit 230 provides the stored data in response to a request of the controller 240.

The controller 240 controls general operations of the base station 111. For example, the controller 240 transmits and receives signals through the wireless communication unit 210 or the backhaul communication unit 220. Also, the controller 240 records and reads data in and from the storage unit 230. For doing so, the controller 240 may include at least one processor. According to various embodiments, the controller 240 may select a core network corresponding to the terminal (e.g., the terminal 121, the terminal 122), and communicate with the selected core network. For doing so, the controller 240 may include a core selection unit 242 which provides functionality for selecting the core network through a message received from the terminal. Herein, the core selection unit 242 may be, as an instruction set or code stored in the storage unit 230, the instructions/code resided in the controller 240 at least temporarily or a storage space storing the instructions/code, or part of circuitry of the controller 240. For example, the controller 240 may control the base station 111 to carry out operations to be explained according to various embodiments.

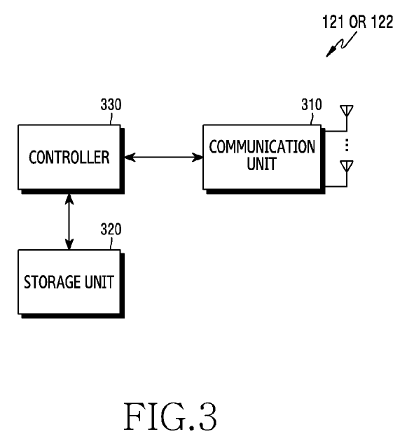

FIG. 3 illustrates a configuration of a terminal in a wireless communication system according to various embodiments of the disclosure. The configuration of FIG. 3 may be understood as a configuration of the terminal 121 or the terminal 122. A term such as ‘portion’ or ‘˜ er’ indicates a unit for processing at least one function or operation, and may be implemented using hardware, software, or a combination of hardware and software.

Referring to FIG. 3, the terminal 121 or the terminal 122 includes a communication unit 310, a storage unit 320, and a controller 330.

The communication unit 310 may perform functions for transmitting and receiving signals over a radio channel. For example, the communication unit 310 performs a conversion function between a baseband signal and a bit string according to a physical layer standard of the system. For example, in data transmission, the communication unit 310 generates complex symbols by encoding and modulating a transmit bit string. Also, in data reception, the communication unit 310 restores a receive bit string by demodulating and decoding a baseband signal. Also, the communication unit 310 up-converts the baseband signal to an RF band signal, transmits it via an antenna, and down-converts an RF band signal received via the antenna to a baseband signal. For example, the communication unit 310 may include a transmit filter, a receive filter, an amplifier, a mixer, an oscillator, a DAC, an ADC, and the like.

Also, the communication unit 310 may include a plurality of transmit and receive paths. Further, the communication unit 310 may include at least one antenna array including a plurality of antenna elements. In view of the hardware, the communication unit 210 may include a digital circuit and an analog circuit (e.g., an RF integrated circuit (RFIC)). Herein, the digital circuit and the analog circuit may be implemented as a single package. Also, the communication unit 310 may include a plurality of RF chains. Further, the communication unit 310 may perform the beamforming.

The communication unit 310 transmits and receives the signals as stated above. Hence, the communication unit 310 may be referred to as a transmitter, a receiver, or a transceiver. In addition, the transmission and the reception over the radio channel is used as the meaning which embraces the above-stated processing of the communication unit 310 in the following explanations.

The storage unit 320 stores a basic program for operating the terminal, an application program, and data such as setting information. The storage unit 320 may include a volatile memory, a non-volatile memory, or a combination of a volatile memory and a non-volatile memory. The storage unit 320 provides the stored data according to a request of the controller 330.

The controller 330 controls general operations of the terminal. For example, the controller 330 transmits and receives signals through the communication unit 310. Also, the controller 330 records and reads data in and from the storage unit 320. For doing so, the controller 330 may include at least one processor or microprocessor, or may be part of a processor. Part of the communication unit 310 and the controller 330 may be referred to as a communication processor (CP). In particular, according to various embodiments, the controller 330 may control to generate and transmit a message including information used by the terminal to select a core network. For example, the controller 330 may control the terminal to carry out operations to be explained according to various embodiments.

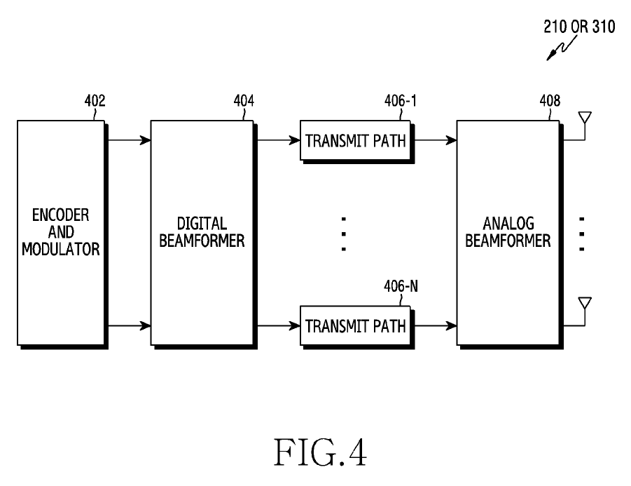

FIG. 4 illustrates a configuration of a communication unit in a wireless communication system according to various embodiments of the disclosure. FIG. 4 depicts a detailed configuration of the wireless communication unit 210 of FIG. 2 or the communication unit 310 of FIG. 3. More specifically, FIG. 4 depicts components for performing the beamforming, as part of the wireless communication unit 210 of FIG. 2 or the communication unit 310 of FIG. 3.

Referring to FIG. 4, the wireless communication unit 210 or the communication unit 310 includes an encoder and modulator 402, a digital beamformer 404, a plurality of transmit paths 406-1 through 406-N, and an analog beamformer 408.

The encoder and modulator 402 performs channel encoding. For the channel encoding, at least one of low density parity check (LDPC) code, convolution code, and polar code may be used. The encoder and modulator 402 generates modulation symbols through constellation mapping.

The digital beamformer 404 beamforms a digital signal (e.g., the modulation symbols). For doing so, the digital beamformer 404 multiplies the modulation symbols by beamforming weights. Herein, the beamforming weights are used to change a level and a phase of a signal, and may be referred to as a precoding matrix or a precoder. The digital beamformer 404 outputs the digital-beamformed modulation symbols to the plurality of transmit paths 406-1 through 406-N. In so doing, according to a multiple input multiple output (MIMO) transmission scheme, the modulation symbols may be multiplexed or the same modulation symbols may be provided to the plurality of transmit paths 406-1 through 406-N.

The plurality of the transmit paths 406-1 through 406-N converts the digital-beamformed digital signals to analog signals. For doing, the plurality of the transmit paths 406-1 through 406-N each may include an inverse fast fourier transform (IFFT) operator, a CP adder, a DAC, and an up-converter. The CP adder is used for an orthogonal frequency division multiplexing (OFDM) scheme, and may be excluded if other physical layer scheme (e.g., filter bank multi-carrier (FBMC)) is applied. That is, the plurality of transmit paths 406-1 through 406-N provides an independent signal process for a plurality of streams generated through the digital beamforming. Notably, depending on the implementation, some of the components of the transmit paths 406-1 through 406-N may be used in common.

The analog beamformer 408 beamforms the analog signals. For doing so, the digital beamformer 404 multiplies the analog signals by the beamforming weights. Herein, the beamforming weights are used to change the level and the phase of the signal. More specifically, the connection structure between the plurality of the transmit paths 406-1 through 406-N and the antennas may be designed to share at least one of the plurality of the transmit paths 406-1 through 406-N, or to connect to antennas which are independently separated.

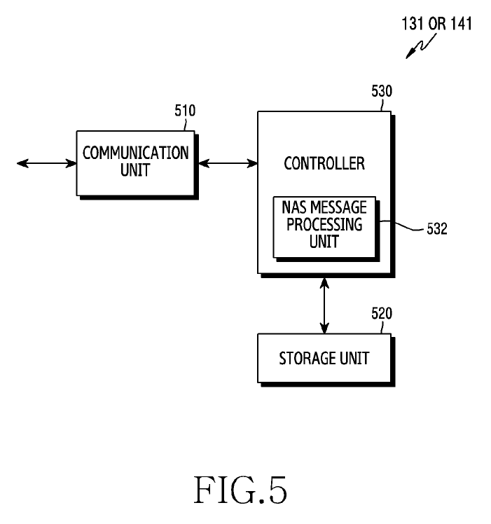

As shown in FIG. 5, the upper node is configured by including a communication unit 510, a storage unit 520, and a controller 530. The configuration of FIG. 3 may be understood a configuration of the upper node 131 or the upper node 141. A term such as ‘portion’ or ‘˜ er’ indicates a unit for processing at least one function or operation, and may be implemented using hardware, software, or a combination of hardware and software.

The communication unit 510 provides an interface for communicating with other network nodes in the network. That is, the communication unit 510 converts a bit sting transmitted from the upper node to other node (e.g., the base station 111), to a physical signal, and converts a physical signal received from the other node to a bit string. That is, the communication unit 510 may transmit and receive signals. Hence, the communication unit 510 may be referred to as a transmitter, a receiver, or a transceiver.

The storage unit 520 stores a basic program for operating the upper node, an application program, and data such as setting information. The storage unit 520 provides the stored data in response to a request of the controller 530.

The controller 530 controls general operations of the upper node. For example, the controller 530 transmits and receives signals through the communication unit 510. Also, the controller 530 records and reads data in and from the storage unit 520. According to an embodiment of the present invention, the controller 530 may include a non-access stratum (NAS) message processing unit 532 for processing a NAS message. According to one embodiment, the NAS message processing unit 532 may identify a suitable core network for the corresponding terminal by analyzing the NAS message. In addition, the NAS message processing unit 532 may redirect the received NAS message. Herein, the NAS message processing unit 532 may be, as an instruction set or code stored in the storage unit 520, the instructions/code resided in the controller 530 at least temporarily or a storage space storing the instructions/code, or part of circuitry of the controller 530. For example, the controller 240 may control the upper node to carry out operations to be explained according to various embodiments.

Various embodiments provide a control method for supporting connection to a suitable communication system according to a type or properties of the terminal, in an environment where different communication systems (e.g., a 4G system and a 5G system) based on different core networks coexist. At this time, various embodiments may be applied to a situation where one of different communication systems evolves to another.

According to various embodiments which will be described later, a radio access network (e.g., the radio access network 100) or a core network (e.g., the first core network 130, the second core network 140) may select a core network corresponding to a terminal (e.g., the terminal 121, the terminal 122) which intends to attach. Herein, embodiments where the core network selects the core network may be referred to as a network based technique, and embodiments where the radio access network selects the core network may be referred to as a radio access network (RAN) based technique.

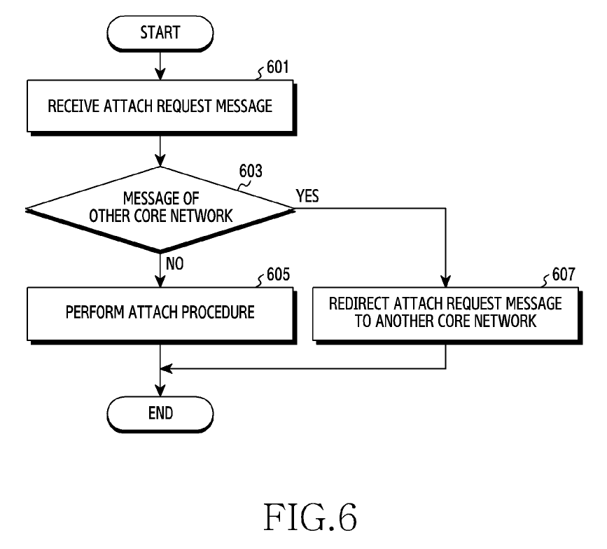

The network based technique conforms to the scheme where the core network is selected at the core network. According to one embodiment, the terminal transmits a message for attaching a default core network among a plurality of core networks, and an upper node of the core network receiving the message selects a core network based on the message. In so doing, if other core network is selected, the upper node receiving the message redirects the message. Procedures according to the network based technique are described below with reference to FIG. 6 through FIG. 8B.

FIG. 6 illustrates an operating method of a core network device in a wireless communication system according to various embodiments of the disclosure. FIG. 6 illustrates operations of the upper node according to the network based core selection technique. FIG. 6 illustrates an operating method of the upper node 131 or the upper node 141.

Referring to FIG. 6, in step 601, the upper node receives an attach request message. That is, the upper node is a device which belongs to a default core network, and receives the attach request message. For example, the attach request message is a NAS message, and may include at least one parameter required for processing the attach procedure such as identification information of the terminal which requests the attach, capability information of the terminal.

Next, in step 603, the upper node determines whether the attach request message is a message of other core network. That is, the upper node determines whether the received attach request message is a message which may be processed by the core network of the upper node. For example, the upper node may determine whether the attach request message is the message of other core network based on a format of the received attach request information or information (e.g., identification information of the core network, information for inferring the core network) included in or received with the received attach request message.

If it is not the message of other core network, in step 605, the upper node performs the attach procedure. That is, if the received attach request message is the message which may be processed by the core network of the upper node, the upper node performs the access procedure of the terminal based on information contained in the attach request message. For example, the upper node may build a data path and a control path for the terminal, and generate a flow/bearer.

By contrast, if it is the message of other core network, in step 607, the upper node redirects the received attach request message to the other core network. That is, if the received attach request message is the message which may be processed at the other core network, the upper node controls to forward the attach request message to a device of the other core network. According to one embodiment, the upper node may transmit to the base station a message requesting to retransmit the attach request message to the device of the other core network. In this case, the message may include at least one of target message information and target core network information. According to another embodiment, the upper node may directly transmit the attach request message to the device of the other core network. In this case, the upper node may packetize or encrypt the attach request message in a format for the redirection.

Hereafter, for the sake of explanations, an entity (e.g., E-EUTRAN, EPC, NGC) defined on the network basis, rather than the device basis, may be described as the operating subject. However, operations described as being performed by the entity on the network basis may be understood as being executed by one device or two or more devices (e.g., a base station, a MME, a GW, a server, an upper node, etc.) belonging to a corresponding network.

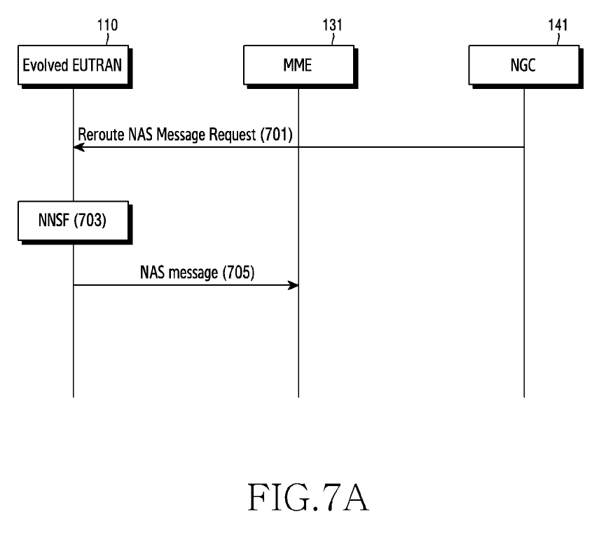

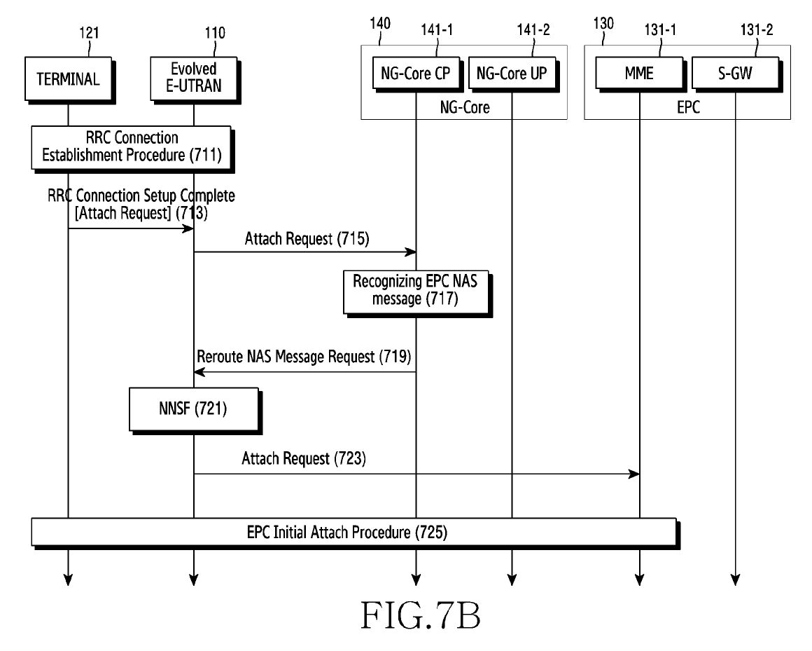

FIG. 7A illustrates a procedure for re-routing a message from a second core network to a first core network in a wireless communication system according to various embodiments of the disclosure. FIG. 7A illustrates that the second core network is the default network, as a first option of the network based technique. Accordingly, NAS attach request messages of both of a terminal supporting a first system and a terminal supporting a second system may be transmitted to the second core network, and the second core network may perform the redirection. That is, the E-EUTRAN transmits every attach request message, that is, an EPC NAS message and an NGC NAS message to the NGC which is the 5G core network.

Specifically, referring to FIG. 7A, in step 701, an upper node 141 of the NGC transmits a reroute NAS message request to an E-EUTRAN 110. That is, the upper node 141 of the NGC requests the base station 111 to transmit an attach request message of the E-EUTRAN 110 to an MME 131 belonging to a first core network 130. Next, in step 703, the E-EUTRAN 110 executes a NAS node selection function (NNSF). In other words, the E-EUTRAN 110 determines a node for processing the NAS message. At this time, the MME 131 is selected. Next, in step 705, the E-EUTRAN 110 transmits a NAS message to the MME 131 belongings to the first core network 130.

FIG. 7B illustrates a detailed procedure for re-routing the message from the second core network to the first core network in the wireless communication system according to various embodiments of the disclosure. FIG. 7B elucidates the procedure of FIG. 7A.

Referring to FIG. 7B, in step 711, a terminal 121 and the E-EUTRAN 110 perform a radio link control (RRC) connection establishment procedure. For doing so, at least one message may be transmitted or received for connection request/response/confirmation between the terminal 121 and the E-EUTRAN 110. In step 713, the terminal 121 transmits an RRC connection setup complete message to the E-EUTRAN 110. At this time, the RRC connection setup complete message includes an attach request message. The attach request message is a NAS message, and may be transmitted to an upper node as its destination. In step 715, the E-EUTRAN 110 transmits the attach request message to an NGC control plane (CP) device 141-1 of the NGC 141-2.

Next, in step 717, the NGC CP device 141 recognizes that the received attach request message is the NAS message of an EPC 130. For example, the NGC CP device 141 may recognize that the received attach request message is the NAS message of the EPC 130, based on a format of the attach request message, or based on information contained in or received with the attach request message. That is, the NGC CP device 141 determines to redirect the attach request message. Next, in step 719, the NGC CP device 141 transmits a reroute NAS message request message to the E-EUTRAN 110. That is, upon receiving the NAS message of the EPC, the NGC 140 which is the 5G core network triggers the re-routing procedure of the NAS message. The reroute NAS message may include information indicating the attach request message received in step 715 and information indicating the EPC 130. For example, the reroute NAS message request message may include a 4G MME group identifier.

Hence, in step 721, the E-EUTRAN 110 executes the NAS node selection function. That is, the E-EUTRAN 110 receives the reroute NAS message request message, identifies the 4G MME group identifier, and performs the 4G MME selection operation. Next, in step 723, the E-EUTRAN 110 transmits an attach request message to the MME 131 of the EPC 130. That is, after the 4G MME selection operation, the E-EUTRAN 110 forwards an EPC NAS message to the MME 131 which is a corresponding 4G MME and thus finishes the core selection procedure. Thus, in step 725, an EPC initial attach procedure is conducted between the EPC 130 and the terminal 121. Specifically, the EPC 130 may obtain identification information of the terminal 121, and the terminal 121 and the EPC 130 may perform authentication, perform an encryption and integrity protection procedure, perform a location update procedure, and established a session.

As in the embodiment described by referring to FIG. 7A and FIG. 7B, the second core network (e.g., the 5G core) may be designated as the default core network. The embodiment which designates the second core network which is a new system as the default core network may be considered as an effective solution for reducing the number of the reroutings, in a situation where terminals which attach to the NGC are greater than terminals which attach to the EPC. In this case, since modifications of the MME belonging to the existing first core network are little or insignificant, it may be easily introduced.

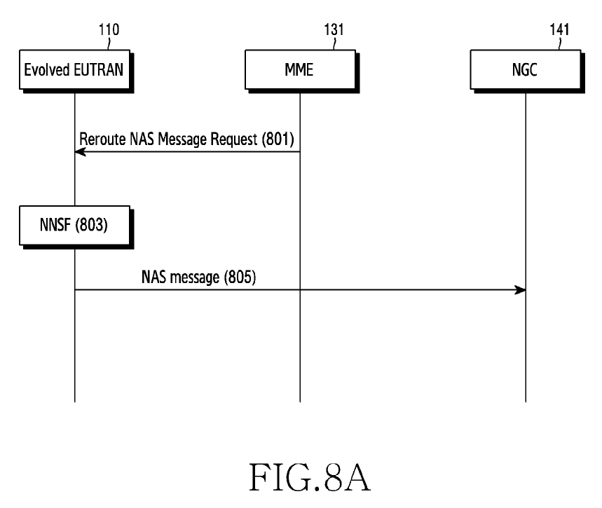

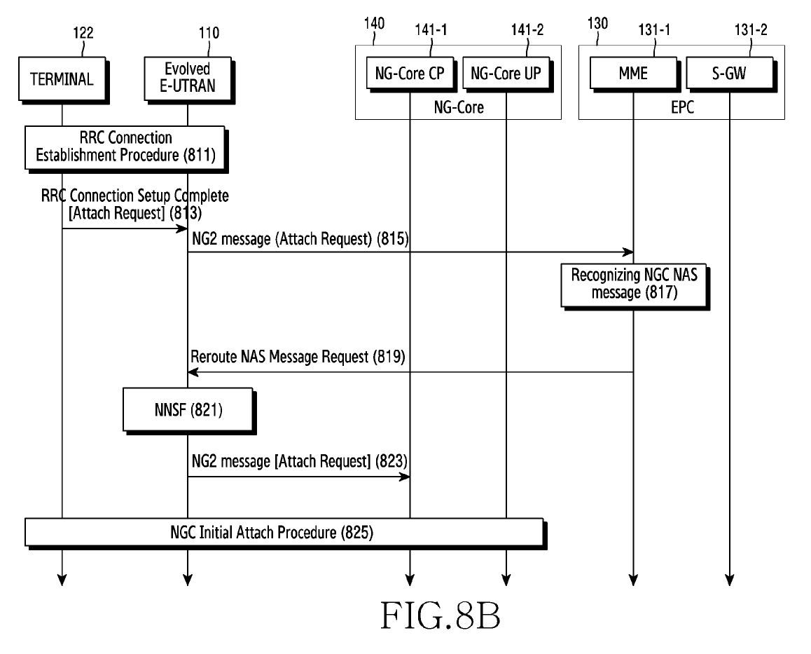

FIG. 8A illustrates a procedure for re-routing a message from a first core network to a second core network in a wireless communication system according to various embodiments of the disclosure. FIG. 8A illustrates that the first core network is the default network, as a second option of the network based technique. Accordingly, NAS attach request messages of both of a terminal supporting a first system and a terminal supporting a second system may be transmitted to the first core network, and the first core network may perform the redirection. That is, the E-EUTRAN transmits every attach request message, that is, an EPC NAS message and an NGC NAS message to the NGC which is the 4G core network.

Specifically, referring to FIG. 8A, in step 801, an MME 131 which is an upper node of the EPC transmits a reroute NAS message request to the E-EUTRAN 110. That is, the MME 131 requests the base station 111 to transmit an attach request message of the E-EUTRAN 110 to the second core network 140. Next, in step 803, the E-EUTRAN 110 executes the NAS node selection function. In other words, the E-EUTRAN 110 determines a node for processing the NAS message. At this time, an upper node 141 of the NGC 140 is selected. Next, in step 805, the E-EUTRAN 110 transmits a NAS message to the upper 141 belongings to the second core network 140.

FIG. 8B illustrates a detailed procedure for re-routing the message from the first core network to the second core network in the wireless communication system according to various embodiments of the disclosure. FIG. 8B elucidates the procedure of FIG. 8A.

Referring to FIG. 8B, in step 811, a terminal 121 and the E-EUTRAN 110 perform an RRC connection establishment procedure. For doing so, at least one message may be transmitted or received for connection request/response/confirmation between the terminal 121 and the E-EUTRAN 110. In step 813, the terminal 121 transmits an RRC connection setup complete message to the E-EUTRAN 110. At this time, the RRC connection setup complete message includes an attach request message. The attach request message is a NAS message, and may be defined for an upper node (e.g., the upper node 131, the upper node 141). In step 815, the E-EUTRAN 110 transmits the attach request message to the MME 131 of the EPC 130.

Next, in step 817, the MME 131 recognizes that the received attach request message is the NAS message of the NGC 140. For example, the MME 131 may recognize that the received attach request message is the NAS message of the NGC 140, based on a format of the attach request message, or based on information contained in or received with the attach request message. That is, the MME 131 determines to redirect the attach request message. Next, in step 819, the MME 131 transmits a reroute NAS message request message to the E-EUTRAN 110. That is, upon receiving the NAS message of the NGC 140, the EPC 130 which is the 4G core network triggers the re-routing procedure of the NAS message. The reroute NAS message may include information indicating the attach request message received in step 815 and information indicating the EPC 130. For example, the reroute NAS message request message may include an NGC group identifier. Herein, the NGC group identifier may be configured in the same format as the MME group identifier, or may be defined in a different format.

Hence, in step 821, the E-EUTRAN 110 executes the NAS node selection function. That is, the E-EUTRAN 110 receives the reroute NAS message request message, extracts the NGC group identifier, and performs an NGC selection operation. Next, in step 823, the E-EUTRAN 110 transmits an attach request message to the NGC CP device 141 of the NGC 140. In so doing, the attach request message may be converted to an NG2 message according to NGC standard, and then transmitted. That is, after the NGC selection operation, the E-EUTRAN 110 forwards an NGC NAS message to the NGC CP device 141 which is the corresponding 5G upper node, and thus finishes the core selection procedure. Thus, in step 825, the NGC initial attach procedure is conducted between the NGC 140 and the terminal 121. Specifically, at least one of the authentication procedure, the encryption and integrity protection procedure, the location update procedure, and the session establishment procedure may be performed between the NGC CP device 141 and the terminal 121.

As in the embodiment described by referring to FIG. 8A and FIG. 8B, the first core network (e.g., the 4G core) may be designated as the default core network. The embodiment which designates the first core network as the default core network may be considered as an effective solution for reducing the number of the reroutings, in a situation where terminals which attach to the EPC are greater than terminals which attach to the NGC.

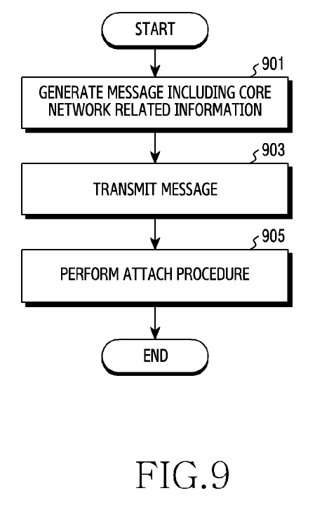

As stated above, in the case of the network based technique, the core network determines whether the attach request message is received from the suitable core network. As another example, the RAN based technique conforms to the scheme which selects the core network at the radio access network. According to one embodiment, the terminal includes information used for selecting the core network in a message transmitted to the base station. Hence, the base station may select the core network, and perform subsequent signaling of the core network with an upper node of the selected core network. Procedures according to the RAN based technique are explained with reference to FIG. 9 through FIG. 15.

FIG. 9 illustrates an operating method of a terminal in a wireless communication system according to various embodiments of the disclosure. FIG. 9 illustrates operations of the terminal according to the RAN based core selection technique. FIG. 9 illustrates the operating method of the terminal 121 or the terminal 122.

Referring to FIG. 9, in step 901, the terminal generates a message including information relating to the core network. In other words, the terminal generates the message including the information used for selecting the core network. That is, the terminal identifies an accessible core network depending on a type or properties of the terminal, and includes information for notifying the identified core network in the message. Herein, the information includes a value corresponding to one of different core networks which may be connected at the base station. For example, the message may be a message used for the radio access procedure to the base station. Specifically, the message may be a message defined in the RRC layer. In addition, the core network related information may be information for explicitly or implicitly indicating the core network to attach, or information for inferring a corresponding core network.

Next, in step 903, the terminal transmits the message. In other words, the terminal transmits the message including the core network related information to the base station. The message may be a message for requesting connection establishment, or a message for notifying connection establishment complete. Alternatively, the message may be another message associated with the initial attach or the reconnection setup.

Next, in step 905, the terminal performs the attach process. That is, the terminal may perform the attach procedure to the core network determined from the message transmitted in step 905. For example, the terminal may establish a radio connection, authenticate the core network, and perform the encryption and integrity production procedure, and establish a session.

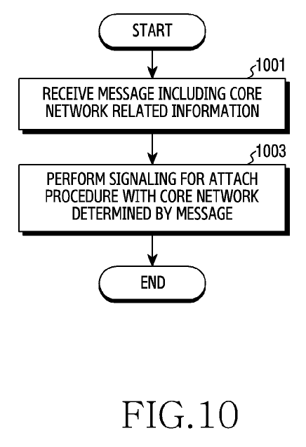

FIG. 10 illustrates an operating method of a base station in a wireless communication system according to various embodiments of the disclosure. FIG. 10 illustrates operations of the base station according to the RAN based core selection technique. FIG. 10 illustrates the operating method of the base station 111.

Referring to FIG. 10, in step 1001, the base station receives a message including information relating to the core network. For example, the message may be a message used for the radio access procedure of the terminal. Specifically, the message may be a message defined in the RRC layer. In addition, the core network related information may be information for explicitly or implicitly indicating the core network to attach, or information for inferring the corresponding core network.

Next, in step 1003, the base station performs signaling for the attach procedure with the core network determined by the message. That is, the base station determines the core network corresponding to the terminal based on the core network related information included in the message. The base station may initiate the attach procedure, by transmitting an attach request message for the terminal to the determined core network.

According to the embodiments described with reference to FIG. 9 and FIG. 10, the terminal may transmit the core network related information, and the base station may select the core network for the terminal using the core network related information. According to one embodiment, the core network related information may be transmitted using the RRC message. In the following, as the RAN based technique, specific embodiments for selecting the core by forwarding the core network related information from the terminal directly to the E-EUTRAN using the RRC message are explained. At this time, depending on how internal field of the RRC message are used, various embodiments are obtained as below.

According to one embodiment, an ‘establishmentCause’ field included in the RRC connection request message may be used. According to 3th generation partnership project (3GPP) LTE release-13, ‘spare1’ exist as shown in Table 1. Thus, by changing ‘spare1’ to indicate the core network, the RAN based core network selection technique may be supported. For example, ‘spare1’ may be changed to ‘5G-connection’, as shown in Table 2.

```
TABLE 1
EstablishmentCause ::= ENUMERATED {
  emergency, highPriorityAccess, mt-Access, mo-Signalling,
  mo-Data, delayTolerantAccess-v1020, mo-VoiceCall-v1280, spare1}
```

```
TABLE 2
EstablishmentCause ::= ENUMERATED {
  emergency, highPriorityAccess, mt-Access, mo-Signalling,
  mo-Data, delayTolerantAccess-v1020, mo-VoiceCall-v1280, 5G-
connection}
```

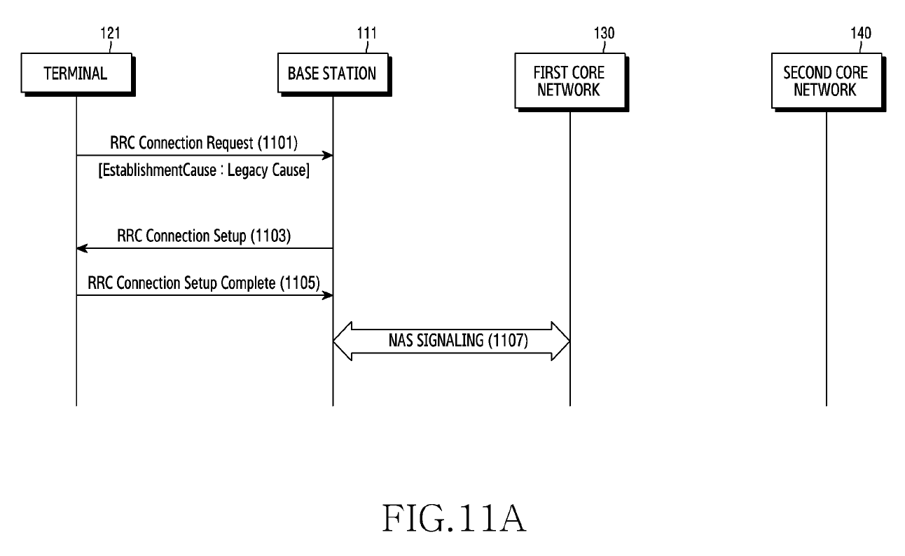

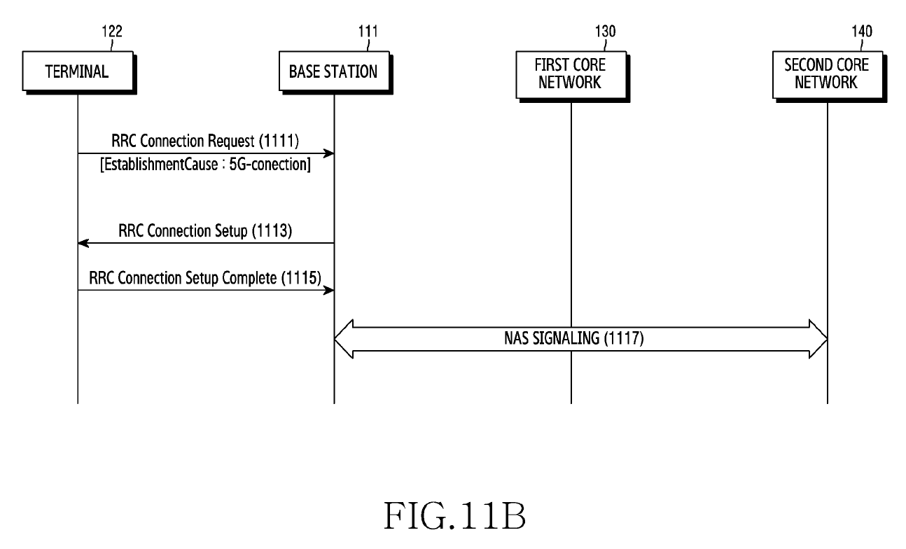

An embodiment using the fields of Table 1 and Table 2 is described with reference to FIG. 11A and FIG. 11B.

FIG. 11A illustrates a procedure for providing information relating to core network selection using a message for a connection request in a wireless communication system according to various embodiments of the disclosure. FIG. 11A illustrates that a first core network 130 is selected.

Referring to FIG. 11A, in step 1101, the terminal 121 transmits an RRC connection request message. At this time, the RRC connection request message includes a ‘EstablishmentCause’ field, and the ‘EstablishmentCause’ field is set to a value corresponding to ‘Legacy Cause’. Specifically, the ‘EstablishmentCause’ field may be set to a value indicating one of ‘emergency’, ‘highPriorityAccess’, ‘mt-Access’, ‘mo-Signalling’, ‘mo-Data’, ‘delayTolerantAccess-v1020’, and ‘mo-VoiceCall-v1280’. Hence, the base station 111 selects the first core network 130, as the core network for the terminal 121.

Next, in step 1103, the base station 111 transmits an RRC connection setup message. In step 1105, the terminal 121 transmits an RRC connection setup complete message. At this time, the RRC connection setup complete message may include an attach request message for attaching to the core network. Next, in step 1107, the base station 111 performs NAS signaling with the first core network 130.

FIG. 11B illustrates another procedure for providing the information relating to the core network selection using the message for the connection request in the wireless communication system according to various embodiments of the disclosure. FIG. 11B illustrates that a second core network 140 is selected.

Referring to FIG. 11B, in step 1111, the terminal 121 transmits an RRC connection request message. At this time, the RRC connection request message includes a ‘EstablishmentCause’ field, and the EstablishmentCause’ field is set to a value corresponding to the 5G core (e.g., the second core network). Specifically, the ‘EstablishmentCause’ field may be set to a value indicating ‘5G-connection’. Hence, the base station 111 selects the second core network 140, as the core network for the terminal 121.

Next, in step 1113, the base station 111 transmits an RRC connection setup message. In step 1115, the terminal 121 transmits an RRC connection setup complete message. At this time, the RRC connection setup complete message may include an attach request message for attaching the core network. Next, in step 1117, the base station 111 performs the NAS signaling with the second core network 140. That is, as the ‘EstablishmentCause’ field is set to ‘5G-connection’, the E-EUTRAN connects to the NR core, that is, the second core network 140.

In the embodiments described with reference to FIG. 11A and FIG. 11B, the base station 111 receives the RRC connection setup complete message, and then performs the NAS signaling. However, if receiving the RRC connection request message, the base station 111 may select the core network. Thus, according to another embodiment, the NAS signaling may be performed before receiving the RRC connection setup complete message.

According to one embodiment, a ‘nonCriticalExtension’ field included in the RRC connection request message may be used. ‘NonCriticalExtension’ is defined as shown in Table 3.

TABLE 3
-- ASN1START

| | |
|---|---|
| RRCConnectionRequest ::= | SEQUENCE { |
| criticalExtensions | CHOICE { |
| rrcConnectionRequest-r8 | RRCConnectionRequest-r8-IEs, |
| criticalExtensionsFuture | SEQUENCE { } |

}
}

| | |
|---|---|
| RRCConnectionRequest-r8-IEs ::= | SEQUENCE { |
| ue-Identity | InitialUE-Identity, |
| establishmentCause | EstablishmentCause, |
| spare | BIT STRING (SIZE (1)) |
| nonCriticalExtension | RRCConnectionRequest-v14-IEs |
| OPTIONAL | |

}

| | |
|---|---|
| InitialUE-Identity ::= | CHOICE { |
| s-TMSI | S-TMSI, |
| randomValue | BIT STRING (SIZE (40)) |

}

| | |
|---|---|
| EstablishmentCause ::= | ENUMERATED { |

```
  mergency, highPriorityAccess, mt-Access, mo-Signalling,
  mo-Data, delayTolerantAccess-v1020, mo-VoiceCall-v1280, spare1}
```

| RRCConnectionRequest-v14-IEs ::= | SEQUENCE { | |
|---|---|---|
| nr-Connection | BOOLEAN | OPTIONAL, |
| nonCriticalExtension | SEQUENCE { } | OPTIONAL |

}
-- ASN1STOP

If generating the RRC connection request message, the terminal sets the value of the ‘nonCriticalExtension’ field. At this time, if the ‘nr-connection’ value is designated as ‘TRUE’ in the ‘nonCriticalExtension’ field, the RRC connection request message indicates the N-core, that is, the second core network. Hence, the base station connects the terminal to the second core network.

According to one embodiment, a ‘registeredMME’ field included in the RRC connection setup complete message may be used. The ‘registeredMME’ field is information included in the RRC connection setup complete message of the 4G system as shown in Table 4, and indicates identification information of the MME registered by the terminal.

TABLE 4
RRCConnectionSetupComplete-r8-IEs ::= SEQUENCE {

| | |
|---|---|
| selectedPLMN-Identity | INTEGER (1..maxPLMN-r11), |
| registeredMME | RegisteredMME |
| OPTIONAL, | |
| dedicatedInfoNAS | DedicatedInfoNAS, |
| nonCriticalExtension | RRCConnectionSetupComplete-v8a0-IEs |
| OPTIONAL | |

}

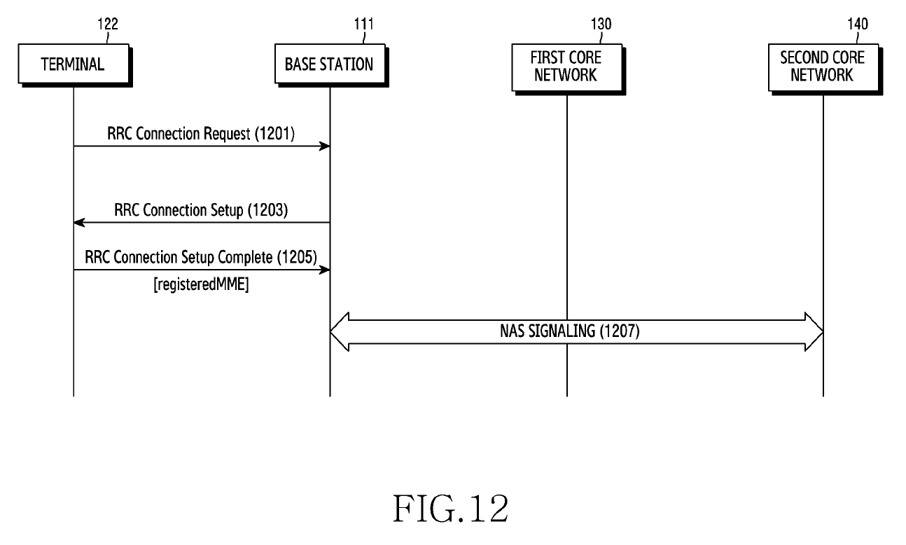

Thus, the core network may be selected, depending on whether the ‘RegisteredMME’ field is set to MME information belonging to the 4G system or to device information belonging to the 5G system. An embodiment using the fields of Table 4 is described with reference to FIG. 12.

FIG. 12 illustrates a procedure for providing information relating to core network selection using a message for connection confirm in a wireless communication system according to various embodiments of the disclosure. FIG. 12 illustrates that the second core network 140 is selected.

Referring to FIG. 12, in step 1201, the terminal 121 transmits an RRC connection request message. Next, in step 1203, the base station 111 transmits an RRC connection setup message. In step 1205, the terminal 121 transmits an RRC connection setup complete message. At this time, the RRC connection setup complete message may include an attach request message for attaching to a core network. In addition, the RRC connection setup complete message includes a ‘registeredMME’ field, and the ‘registeredMME’ field is set to information (e.g., identification information of the upper node of the second core network 140) corresponding to the second core network 140. Accordingly, the base station 111 selects the second core network 140, as the core network for the terminal 121. Next, in step 1207, the base station 111 performs the NAS signaling with the second core network 140.

According to one embodiment, a ‘dedicatedInfoNAS’ field included in the RRC connection setup complete message may be used. The ‘dedicatedInfoNAS’ field of Table 5 is a field used to transmit an upper message (e.g., a NAS message) of the terminal.

TABLE 5
RRCConnectionSetupComplete-r8-IEs ::= SEQUENCE {

| selectedPLMN-Identity | INTEGER (1..maxPLMN-r11), | |
|---|---|---|
| registeredMME | RegisteredMME | OPTIONAL, |
| dedicatedInfoNAS | DedicatedInfoNAS, | |
| nonCriticalExtension | RRCConnectionSetupComplete- | |
| | v8a0-IEs | |
| OPTIONAL | | |

}

Through the ‘dedicatedInfoNAS’ field, the terminal may transmit the upper message of the terminal to the core network. The ‘dedicatedInfoNAS’ field may include an attach request message which is the upper message, and the attach request message is defined as shown in Table 6.

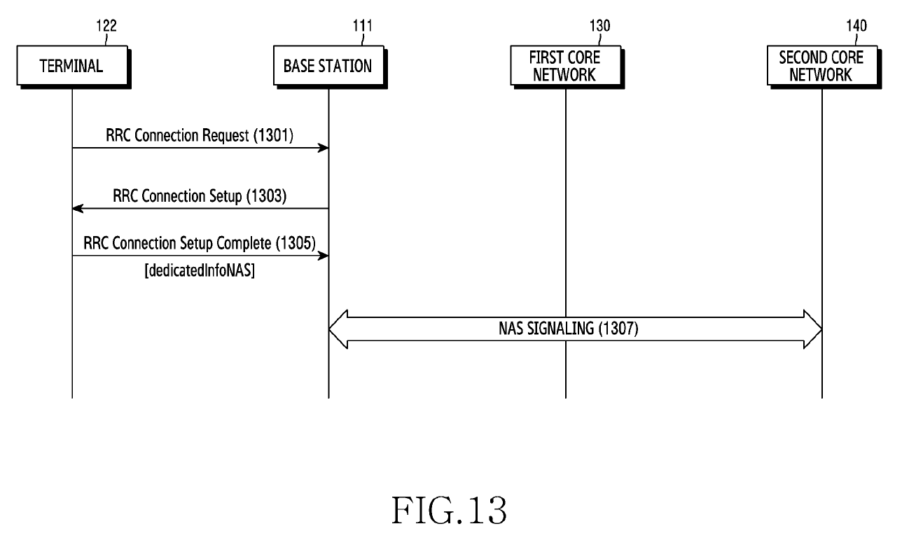

By including information requiring 5G connection in the attach request message which is the NAS message of Table 6, the ‘dedicatedInfoNAS’ field may be used to select the core network. For example, the reserved value ‘111’ in ‘EPS attach type’ in Table 6 may be defined for the purpose of indicating the 5G core, that is, the second core network 140. An embodiment using the fields of Table 5 is described with reference to FIG. 13.

FIG. 13 illustrates another procedure for providing information relating to core network selection using a message for connection confirmation in a wireless communication system according to various embodiments of the disclosure. FIG. 13 illustrates that the second core network 140 is selected.

Referring to FIG. 13, in step 1301, the terminal 121 transmits an RRC connection request message. Next, in step 1303, the base station 111 transmits an RRC connection setup message. In step 1305, the terminal 121 transmits an RRC connection setup complete message. At this time, the RRC connection setup complete message may include an attach request message for attaching to a core network. In addition, the RRC connection setup complete message includes a ‘dedicatedInfoNAS’ field, the ‘dedicatedInfoNAS’ field includes the attach request message which is the NAS message, and a ‘EPS attach type’ field of the attach request message is set to a value indicating the second core network 140. Thus, the base station 111 selects the second core network 140 as the core network for the terminal 121. Next, in step 1307, the base station 111 performs the NAS signaling with the second core network 140.

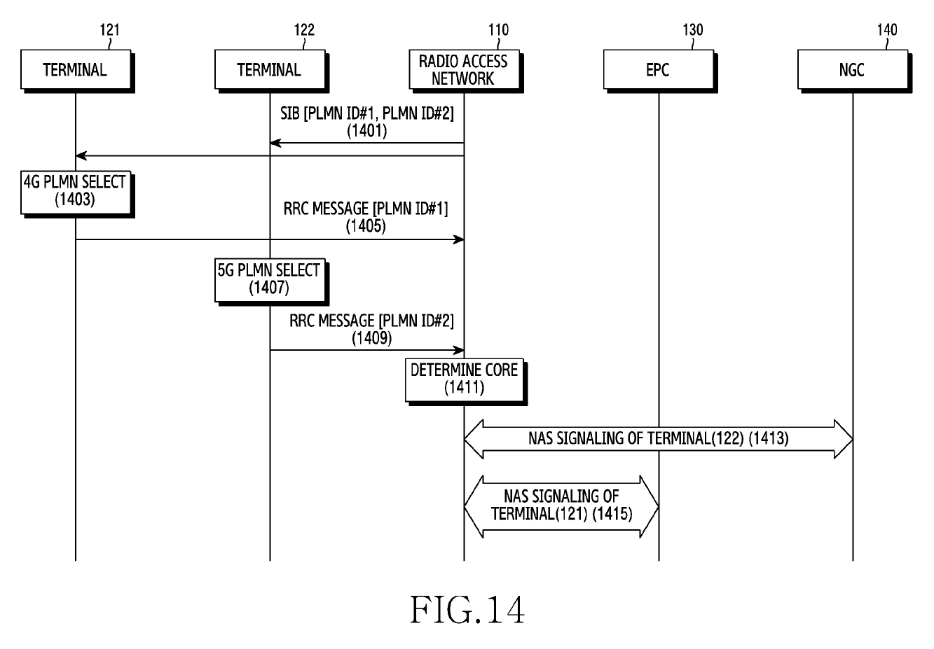

According to one embodiment, a ‘selectedPLMN-Identity’ field included in the RRC connection setup complete message may be used. The ‘selectedPLMN-Identity’ field is used to deliver public land mobile network (PLMN) information of a network operator selected by the terminal. That is, as the RAN based technique, a solution for utilizing the PLMN information may be considered. If the E-EUTRAN belongs to both of 4G PLMN and 5G PLMN, the base station may broadcast 4G/5G PLMN IDs using system information block (SIB) messages. At this time, the NGC terminal supporting the 5G system may select the PLMN ID of the 5G, and transmit the selected PLMN ID using an RRC message, and the E-EUTRAN may perform the core selection based on the PLMN ID received from the terminal. That is, if the PLMN ID of the 5G is included in the RRC message, the E-EUTRAN may forward the NAS message to the 5G core (e.g., the second core network). If the PLMN ID of the 4G is included in the RRC message, the E-EUTRAN may forward the NAS message to the 4G core (e.g., the first core network). An embodiment using a ‘selectedPLMN-Identity’ field is described with reference to FIG. 14.

FIG. 14 illustrates a procedure for providing information relating to core network selection using identification information for an operator in a wireless communication system according to various embodiments of the disclosure.

Referring to FIG. 14, in step 1401, the radio access network 110 transmits a SIB. The SIB is a message which is broadcast to a plurality of terminals including the terminal 121 and the terminal 122. At this time, the SIB includes at least one PLMN identifier. For example, the SIB may include PLMN ID#1 corresponding to the EPC 130 and PLMN ID#2 corresponding to the NGC 140.

Next, in step 1403, the terminal 121 selects a 4G PLMN, that is, the PLMN corresponding to the first system. In step 1405, the terminal 121 transmits an RRC message (e.g., an RRC connection setup complete message) including the PLMN ID#1. Also, in step 1407, the terminal 122 selects a 5G PLMN, that is, the PLMN corresponding to the second system. In step 1409, the terminal 122 transmits an RRC message (e.g., an RRC connection setup complete message) including the PLMN ID#2.

Accordingly, in step 1411, the radio access network 110 determines core networks for the terminal 121 and the terminal 122 respectively. In the example of FIG. 14, the radio access network 110 selects the EPC 140 as the core network for the terminal 121, and selects the NGC 140 as the core network for the terminal 122. In other words, as receiving the RRC message including the PLMN ID#1 corresponding to the EPC 130 from the terminal 121, the radio access network 110 selects the EPC 130 as the core network for the terminal 121. As receiving the RRC message including the PLMN ID#2 corresponding to the NGC 140 from the terminal 122, the radio access network 110 selects the NGC 140 as the core network for the terminal 122. Next, in step 1413, the radio access network 110 performs the NAS signaling for the terminal 122 with the NGC 140. In step 1415, the radio access network 110 performs the NAS signaling for the terminal 121 with the EPC 130.

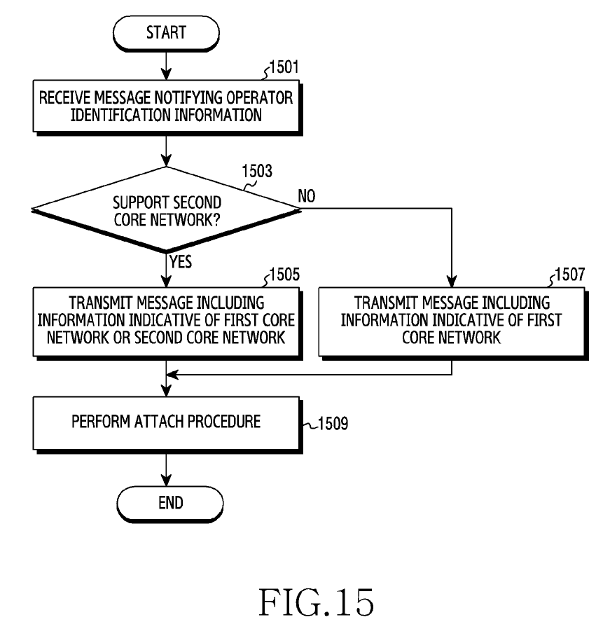

In the embodiments described with reference to FIG. 11A through FIG. 14, the terminal may notify the core network to attach by use of the RRC message. In this case, the terminal may select the core network based on the type or properties of the terminal. However, if the base station which communicates with the terminal does not support the second core network, the attach to the second core network may not be possible regardless of the type of the terminal. Thus, according to one embodiment, the terminal may determine whether the base station supports the connection to the second core network, and then transmit information regarding the core network. For doing so, network operator information (PLMN information) broadcast from the base station may be used. An embodiment for determining whether the second core network is supported using the PLMN is described with reference to FIG. 15.

FIG. 15 illustrates another operating method of a terminal in a wireless communication system according to various embodiments of the disclosure.

Referring to FIG. 15, in step 1501, the terminal receives a message notifying identification information of an operator. The message may be information which is broadcast from the base station to forward system information. The identification information of the operator may include PLMN ID. At this time, the message includes at least one PLMN ID.

Next, in step 1503, the terminal determines whether the second core network is supported. In other words, the terminal determines whether the base station transmitting the message supports the second core network. For doing so, the terminal uses the PLMN ID included in the message. According to one embodiment, the terminal may determine whether the second core network is supported based on the number of the PLMN IDs included in the message. In this case, if a plurality of PLMN IDs is included, the terminal may determine that the second core network is supported. According to other embodiment, the terminal may determine whether the second core network is supported based on the PLMN ID. In this case, if the PLMN ID corresponds to the second core network, the terminal may determine that the second core network is supported. Herein, whether the PLMN ID corresponds to the second core network may be determined based on a structure of the PLMN ID, or based on whole or part of the value. As such, the terminal may identify different core networks connectable by the base station based on the network operator information received from the base station.

If the second core network is supported, in step 1505, the terminal transmits a message including information indicative of the first core network or the second core network. If the terminal supports both of the first system (e.g., 4G system) and the second system (e.g., 5G system), the terminal may select the core network according to other conditions, and operate to attach to the selected core network. Alternatively, if the terminal supports only the second core network (e.g., 5G system), the terminal may operate to access the second core network. At this time, the information indicating the core network may be processed according to one of the embodiments described with reference to FIG. 11A through FIG. 14 or other embodiment. Specifically, the terminal may transmit information used to select the core network using at least one of the ‘establishmentCause’ field, the ‘nonCriticalExtension’ field of the RRC connection complete message, the ‘registeredMME’ field, the ‘dedicatedInfoNAS’ field, the selectedPLMN-Identity field of the RRC connection setup message.

By contrast, if the second core network is not supported, in step 1507, the terminal transmits a message including information indicative of the first core network. However, if the terminal does not support the first core network, the terminal nor not proceed to step 1507 but may terminate the procedure.

Next, in step 1509, the terminal performs the attach procedure. That is, the terminal may perform the procedure for attaching the core network determined from the message transmitted in step 1505 or step 1507. For example, the terminal may establish a wireless connection, authenticate the core network, perform the encryption and integrity protection procedure, and establish a session.

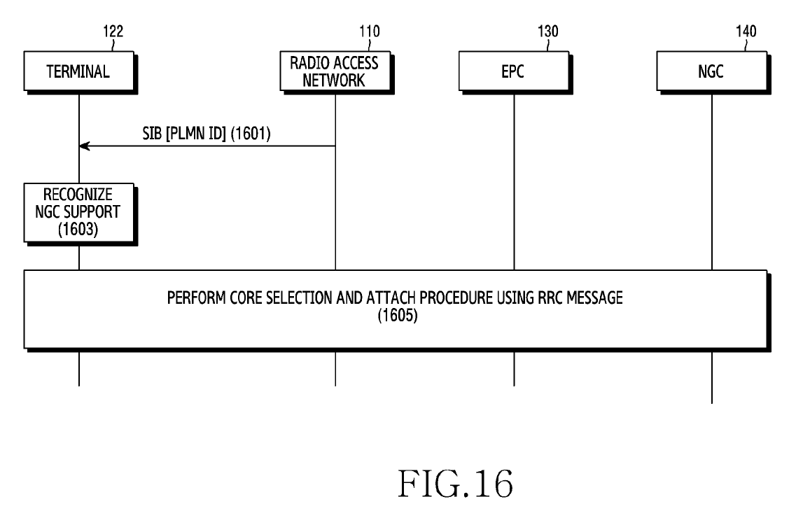

FIG. 16 illustrates a procedure for initiating a procedure which provides information relating to core network selection using operator identification information in a wireless communication system according to various embodiments of the disclosure. FIG. 16 illustrates that the NGC, that is, the second core the network is supported.

Referring to FIG. 16, in step 1601, the radio access network 110 transmits an SIB. The SIB is a message broadcast for a plurality of terminals including the terminal 122. At this time, the SIB includes at least one PLMN identifier. For example, the SIB includes a PLMN ID corresponding to the NGC 140. Accordingly, in step 1603, the terminal recognizes that the NGC 140 is supported in the radio access network 110. Next, the terminal determines to attach to the NGC 140.

Next, in step 1605, the terminal performs the core selection and the attach procedure using an RRC message. Specifically, the terminal may transmit information regarding the selected core network to the radio access network 110 using the RRC message, and then perform the attach procedure through the NAS signaling.

The methods according to the embodiments described in the claims or the specification of the disclosure may be implemented in hardware, software, or a combination of hardware and software.

For the software implementation, a computer-readable storage medium which stores one or more programs (software modules) may be provided. One or more programs stored in the computer-readable storage medium may be configured for execution by one or more processors of an electronic device. One or more programs may include instructions for enabling the electronic device to execute the methods according to the embodiments described in the claims or the specification of the disclosure.

Such a program (software module, software) may be stored to a random access memory, a non-volatile memory including a flash memory, a read only memory (ROM), an electrically erasable ROM (EEPROM), a magnetic disc storage device, a compact disc (CD)-ROM, digital versatile discs (DVDs) or other optical storage devices, and a magnetic cassette. Alternatively, the programs may be stored to a memory combining part or all of them. Also, a plurality of memories may be included.

Also, the programs may be stored in an attachable storage device accessible via a communication network such as Internet, Intranet, LAN, wide LAN (WLAN), or storage area network (SAN), or a communication network by combining these networks. Such a storage device may access an apparatus which realizes an embodiment of the disclosure through an external port. Also, a separate storage device on the communication network may access the apparatus which realizes an embodiment of the disclosure.

In the specific embodiments of the disclosure as described above, the elements included in the disclosure are expressed in a singular or plural form. However, the singular or plural expression is appropriately selected according to a proposed situation for the convenience of explanations, the disclosure is not limited to a single element or a plurality of elements, the elements expressed in the plural form may be configured as a single element, and the elements expressed in the singular form may be configured as a plurality of elements.

Meanwhile, the detailed description of the disclosure has been described with reference to certain embodiments thereof, but various modifications may be made without departing from the scope of this disclosure. Therefore, the scope of this disclosure should not be limited to the described embodiments but should be defined by the claims as below and their equivalents within the scope of the claims.

1. A terminal in a wireless communication system, the terminal comprising:
a transceiver; and
at least one processor coupled to the transceiver and configured to:
generate a message comprising information that is used to select a core network; and
transmit, to a base station, the message,
wherein the information comprises a value corresponding to one of core networks.

2. The terminal of claim 1, wherein the message comprises at least one of a radio resource control (RRC) connection request message and an RRC connection setup complete message.

3. The terminal of claim 1, wherein the message comprises a ‘establishmentCause’ field associated with the core network.

4. The terminal of claim 1, wherein the at least one processor is further configured to identify the core networks connectable by the base station based on information regarding a network operator received from the base station.

5. The terminal of claim 1, wherein the information comprises identification information of a public land mobile network (PLMN) of a core network to that the terminal attaches.

6. A base station in a wireless communication system, the base station comprising:
at least one transceiver; and
at least one processor coupled to the at least one transceiver and configured to:
receive, from a terminal, a message that comprises information used to select a core network; and
transmit a message for attaching to the core network for the terminal determined based on the information,
wherein the information comprises a value corresponding to one of core networks connectable by the base station.

7. The base station of claim 6, wherein the message comprises one of a radio resource control (RRC) connection request message and an RRC connection setup complete message.

8. The base station of claim 6, wherein the message comprises a ‘establishmentCause’ field associated with the core network.

9. The base station of claim 6, wherein the at least one processor is further configured to transmit system information including information regarding a public land mobile network (PLMN) associated the core network.

10. The base station of claim 9, wherein the information regarding the PLMN comprises a public land mobile network (PLMN) identifier (ID).

11.-14. (canceled)

15. The terminal of claim 1, wherein the at least one processor is further configured to receive, from the base station, system information including information regarding a public land mobile network (PLMN) associated the core network.

16. The terminal of claim 1, wherein the at least one processor is further configured to identify the core network based on the information regarding a PLMN.

17. The terminal of claim 1, wherein the core networks comprises an evolved packet core (EPC) and a fifth generation core (5GC).

18. A method for operating a terminal in a wireless communication system, the method comprising:
generating a message comprising information that is used to select a core network; and
transmitting, to a base station, the message,
wherein the information comprises a value corresponding to one of core networks connectable by the base station.

19. The method of claim 18, wherein the message comprises at least one of a radio resource control (RRC) connection request message and an RRC connection setup complete message.

20. The method of claim 18, wherein the message comprises a ‘establishmentCause’ field associated with the core network.

21. The method of claim 18, further comprising:
identifying the core networks connectable by the base station based on information regarding a network operator received from the base station.

22. The method of claim 18, wherein the information comprises identification information of a public land mobile network (PLMN) of a core network to that the terminal attaches.

23. The method of claim 18, further comprising:
receiving, from the base station, system information including information regarding a public land mobile network (PLMN) associated the core network.

24. The method of claim 18, further comprising:
identifying the core network based on the information regarding a PLMN.
